(19) United States
(12) Patent Application Publication
(10) Pub. No.: US 2020/0220360 A1
(43) Pub. Date: Jul. 9, 2020

(54) Grid independent AC/DC Electrical power generation system

(71) Applicant: Steven L. Cornelius, Taft, TN (US)

(72) Inventor: Steven L. Cornelius, Taft, TN (US)

(21) Appl. No.: 16/350,774

(22) Filed: Jan. 9, 2019

(51) Int. Cl. H02J 3/38; H02M 7/44; H02M 3/04; H02S 40/32

(52) U.S. Cl. CPC H02J 3/383; H02J 3/386; H02S 40/32; H02M 3/04; H02M 7/44

(57) ABSTRACT

The ability to power an off-grid device, such as a lighting system or wide-area computer network (Wi-Fi) hotspot is maximized and made self-sustaining by introducing an apparatus that provides energy storage and recharging capability by way of a series of interconnected photo-voltaic (PV) panels that are scalable in number, and microprocessor-controlled power supply/converter unit(s) recharging an inter-connected bank of deep cycle direct current (DC) batteries, with type used and number dependent upon end-user requirements and application. The intelligent controller will be built to include a removable memory/firmware device containing a system control program consisting of about 16,000 lines of C+ code. This code may be reconfigured as required to optimize the device for its operating environment, (see Claim 1 above). In this way, the power generation system may be quickly reconfigured to best suit the operating environment in which it is deployed. The system intelligent control unit monitors and at user/owner determined intervals interrogates the PV-panels and batteries, recording and transmitting system operational status to a data collection/analysis station. The entire apparatus (Direct Current (DC) or Alternating Current (AC) electrical power generation system)) may be configured to act as an independent power supply for remote devices.

The ability to power an off-grid device, such as a lighting system or local or wide-area computer network (LAN/WAN) or Wi-Fi hotspots is maximized and made self-sustaining by introducing an apparatus that provides energy storage and recharging capability (FIG. 1) by way of a series of interconnected photo-voltaic (PV) panels (FIG. 1: 20) that are scalable in number, and microprocessor-controlled power supply/converter unit(s) (FIG. 1, 50) recharging an inter-connected bank of deep cycle direct current (DC) batteries (FIG. 1: 47), with type used and number dependent upon end-user requirements and application. A rapidly reconfigurable system control unit (FIG. 1, 50) monitors and at user/owner determined intervals interrogates the PV-panels and batteries, recording and transmitting system operational status to a data collection/analysis station (FIG. 5, 51). The system intelligent controller (FIG. 1: 50) is rapidly reconfigurable via a removable control program language module. The removable control software is contained entirely on a memory device (firmware—FIG. 1, 50). The entire apparatus (Direct Current (DC) electrical power generation system may be configured to act as an independent power supply for remote devices.

### SPECIFICATION

The complete system (FIG. 1) is separated into two interdependent segments:

A: Direct Current (DC) power supply, including battery bank for energy storage (FIG. 1: 47). Energy to operate DC powered devices (lights, wireless computer network antennae, etc.) is stored in and drawn from the DC battery bank (FIG. 1, 40) as required for sustained device operation. The power supply system includes an intelligent network enabled controller (Intelligent Controller), capable of monitoring all system operations and providing status to the user/owner via a dedicated software application running on a smart device (phone, tablet or personal computer). In this application, the design also incorporates the ability (via connection sockets/terminals) to accommodate an inverter system allowing DC to AC power conversion.

B: Solar recharge system (FIG. 2: 3 & FIG. 4: 40a).

Combined Approach reflects all functional components identified in FIG. 1 (10): Primary battery recharge method is via a series of photo-voltaic panels (FIG. 2: 22, 22a-h) connected to the battery bank through a charge controller (40a). The apparatus also provides PV panel (FIG. 2: 22, 22a-h) by PV panel (FIG. 2: 22, 22a-h) status via diagnostic features incorporated into a unique Intelligent Controller (FIG. 5: 50) and it can communicate with external devices for full system status reporting and remote control of certain key functions, such as on/off, and power supply shunting between PV, wind and generator.

### CROSS-REFERENCE TO RELATED APPLICATION

None.

### STATEMENT REGARDING FEDERALLY SPONSORED RESEARCH OR DEVELOPMENT (IF APPLICABLE)

None.

### REFERENCE TO SEQUENCE LISTING, A TABLE, OR A COMPUTER PROGRAM LISTING COMPACT DISC APPENDIX (IF APPLICABLE)

None

### BACKGROUND OF THE INVENTION

The present invention is directed to a DC electric power generation system, and more particularly, to a solar-based electric power generation system that is efficient, predictable and reliable.

In particular, a preferred embodiment of the invention relates to a method for powering DC electrical devices using power generated by photovoltaic modules (PV panels) and stored within an array of deep cycle batteries so as to maximize photovoltaic power generation system efficiency, comprised of said photovoltaic array.

The invention also relates to complimentary electronic apparatus installed between the PV array and inverters (when used) such as the intelligent, rapidly reconfigurable system control and monitoring unit (Intelligent Controller, FIG. 5: 50) complimentary to photovoltaic power generation systems for monitoring, managing and conditioning said photovoltaic power generation systems. The invention operates as an autonomous power generation system with no national/regional grid tie or dependency.

### BRIEF SUMMARY OF THE INVENTION

An off-grid DC or AC power system consisting of a variable number of batteries for energy storage, and using photo-voltaic, a wind generator and natural gas-powered auxiliary generator to maintain battery bank state of charge. An intelligent controller utilizes custom software code to monitor and control the overall system. Key elements of the intelligent controller include: 1) the capability to switch between solar, wind or auxiliary generator to maintain battery charge state; 2) turning the system on and off remotely using activation-deactivation switches; 3) health and status monitoring via a series of sensors placed throughout the apparatus; 4) The intelligent controller will include a removable memory/firmware device containing a system control program consisting of about 16,000 lines of C+ code. This code may be reconfigured as required to optimize the device for its operating environment, (see Claim 1 above). In this way, the power generation system may be quickly reconfigured to best suit the operating environment in which it is deployed. The system intelligent control unit monitors and at user/owner determined intervals interrogates the PV-panels and batteries, recording and transmitting system operational status to a data collection/analysis station. The entire apparatus (Direct Current (DC) or Alternating Current (AC) electrical power generation system)) may be configured to act as an independent power supply for remote devices.

### DESCRIPTION OF PRIOR ART

There is limited prior art concerning a hybrid AC/DC power generation system, therefore PV systems will be used as an illustrative example. In most common photovoltaic power generation systems currently fielded, a defined number of PV panels are wired in series, creating a string of complimentary (balanced) panels. In such a system, any number of identical strings may be connected in parallel to a direct current (DC) power bus that is then connected, usually to a grid-tied inverter.

Electrically, a photovoltaic system can be seen as a parallel series of voltage generators, with their internal series resistance and a cumulative bypass diode in series (corresponding to a string of PV modules wired in series), the voltage of the DC bus (VDC bus) being the main DC supply of the inverter.

Every current generating PV panel string is a part of the total/constituent current such that the aggregate power amount at the inverter input point is total current multiplied VDC bus.

The entire system comprises photovoltaic modules, connectors, DC wiring, bypass diodes, string fuses, string converters and central inverters and it results in a complex electrical system that only develops maximum power when it is perfectly balanced, that is, when all photovoltaic panels are evenly irradiated and electrically balanced, and all the other components are homogeneous and balanced.

In order to improve the global efficiency of photovoltaic power generation system the first solution developed was the introduction of high efficiency DC to DC converters, usually called string converters because they are placed one per string, and able to perform MPPT (Maximum Power Point Tracking). By means of an MPPT string converter it is possible to control the voltage before entering the main DC bus and simplify the current sharing.

To improve the efficiency of single PV module an electronic device is placed at the output of each PV module. Strings become series of such electronic devices which are either connected directly through the VDC bus to the central inverter or they are connected to string converters.

The electronic device acts as a current limiter/step-up (always boosting) power supply. By measuring voltage and current from the PV module and comparing them to I-V and/or P-V characteristic curves of the PV module, it can determine if a module is not in a full-power behavior and, in case, it stops boosting. It increases the voltage at the output but limits the current and the PV module roughly remains around its maximum power point.

Especially when they are combined with MPPT string converters such electronic devices improve the efficiency of the PV system, but they do not solve the string hard disconnection because there is no feedback by the entire string voltage. In addition, such electronic devices perform an always boosting power conditioning that do not allow the MPPT string converter (or the MPPT of the entire system) to reach a working point that is a real and global maximum.

The above can be obtained, for instance, through WO 2008/195215 which discloses a method and apparatus for efficiently monitoring the operation of a harvesting system using DC power sources. WO 2008/195215 provides a plurality of monitoring modules each associated to a power source and collecting performances of the associated power sources, a plurality of transmitters for transmitting data collected by the monitoring modules to controller modules and a central analysis station for receiving performance data from the monitoring modules, said central analysis station being able to analyze fault detection. An electronic device described in WO 2008/195215 which is associated to a DC power source is a DC to DC converter which comprises a power conversion controller which is coupled to a microcontroller including an MPPT module and a communication module. It also comprises current and voltage sensor for measuring current and voltage values at the output of the DC power source provided for allowing the power conversion controller to maintain the converter input power at the maximum power point. The buck and boost portions of the converter are controlled according to the measured converter output and to an MPPT algorithm implemented in the controller.

The microcontroller of the electronic unit may also receive data from external sensors such as ambient temperature sensors, solar radiance sensors or sensors from neighboring panels (specific DC power source). Data from the above sensors, as well as current and voltage data are used only to perform analysis of the state of the DC power source by the central analysis station, that is to detect failures or inefficiency of the panels. The central analysis station is not able to affect the power conversion of each electronic unit as one-way communication is used and when a bidirectional communication is used it is just to let the central analysis station request the data collected by the electronic units. The power conversion operated in each electronic unit is managed by its power conversion controller and microcontroller which operate taking into account voltage and current at the output of the associated DC power source and voltage and current at the output of its power converter. The result is an internal optimization of the power production that cannot take into account the power produced in the other electronic units of the string or system. It is also known a further electronic device to be connected exactly like any other PV module at the end of the string. It is able to create virtual voltages and currents starting from the DC bus and flowing towards the device, by using a high-voltage input step down topology. This way the main DC bus becomes the power source and the feedback of the system so allowing effectively balancing the string. The above electronic device is also able to provide diagnostic features and to predict the need for a cleaning, ground faults or the like, but only at string level. There is no precise information on single PV modules. Another limit of the device is that the string current is still limited by the bottle neck PV module, so the optimization too is limited in the string balancing minus conversion power losses (as higher as the DC bus voltage increases because the buck coefficient becomes really big and the components in the power stage of the device have to fulfil to very large and time-short current pulses).

As it is clear from the above the need for an independent (non-grid tied) DC/AC power system with an intelligent controller possessing self-diagnosing and reporting capabilities has not been satisfied. The need for an intelligent, self-monitoring and reporting DC/AC PV-based power generation system remains, since no devices of the known art are able to perform in such a manner.

In addition, no device of the known art is able to guarantee diagnostic features at PV module level so that troublesome modules cannot be exactly identified and consequently maintained or repaired.

### SUMMARY OF TILE INVENTION

It is the object of the present invention to propose a method for a DC or AC power generation system designed expressly to operate independent of the national/regional grid and supply necessary power to a variety of DC and AC powered applications, such as a wireless computer network antenna using a number of DC batteries, voltage, configuration and quantity determined by application, connected in parallel as an energy storage apparatus and DC energy source. In the first embodiment, to provide recharge capability for the battery bank, a series of solar panels, the number of which will vary depending upon power loading and quantity of batteries to be recharged will be employed as part of the overall system design. A wind turbine and natural gas power generator provide back-up charging sources when there isn't adequate sunshine. The use of multiple charging sources constitutes a hybrid approach to maintaining adequate charge in the battery bank to power end-use devices.

In another embodiment, the system has a separate electrical power supply and state signaling system, which provides power and operational state commands to control apparatus. A programmable micro-controller-based device (Intelligent Controller) is employed, which uses custom software written specifically for this application. The Intelligent Controller monitors power output and other operational parameters through a series of redundant sensors installed on, for example, the solar panels, batteries, solar charge controller, wind turbine and natural gas generator and other system components and reports status to the system owner/operator, thus enabling the electricity generating system to predictably and reliably provide system rated power to a connected AC or DC electrical device.

The intelligent controller will be built to include a removable memory/firmware device containing a system control program consisting of about 16,000 lines of C+ code. This code may be reconfigured as required to optimize the device for its operating environment, (see Claim 1 above). In this way, the power generation system may be quickly reconfigured to best suit the operating environment in which it is deployed. The system intelligent control unit monitors and at user/owner determined intervals interrogates the PV-panels and batteries, recording and transmitting system operational status to a data collection/analysis station. The entire apparatus (Direct Current (DC) or Alternating Current (AC) electrical power generation system)) may be configured to act as an independent power supply for remote devices.

In another particular embodiment, the system has a specific quantity of storage cells (batteries) such as deep cycle, absorbed glass mat (AGM) or lithium, a solar charge controller and Intelligent Controller (solar panel and battery charge state monitoring device). This dedicated control and monitoring system receives discreet condition or operational state signals based upon system load, which in turn generates binary signals used to control the system. For example, if the control/monitoring system detects low battery charge state, and no available recharge voltage from the solar panel bank, it may generate a signal to turn off power supply to using devices. Alternatively, the Intelligent Controller may also generate control signals to increase the battery charge rate (when high solar panel output is available necessary to maintaining desired battery charge state). Alternatively, the Intelligent Controller can, if the components have been included in the system design and are connected and recognized (registered with the intelligent controller), generate a signal to turn on a generator or connect a wind turbine power source.

In a preferred embodiment the electronic units also comprise batteries, battery charging/power managing means and working and/or connection status signaling means. Still in a preferred embodiment the managing units also comprise a memory-based means for data gathering and logging, a supervision application capable of controlling the status and activity of the managing unit and communication interface to data networks using various communication protocols.

### BRIEF DESCRIPTION OF THE DRAWINGS

These and other characteristics of the invention will be clear from the following description of preferred forms of embodiment, given as a non-restrictive example, with reference to the attached drawings wherein:

FIG. 1 shows a schematic representation of the entire PV power generation system comprising the apparatus of the invention;

FIG. 2 shows the PV power generation array (system), including status monitoring sensors, as part of FIG. 1;

FIG. 3 shows a functional block diagram of electrical connections between the PV array and battery bank according to the invention;

FIG. 4 shows a functional block diagram of the battery bank portion and charge controller of a self-contained DC power production unit according to the invention;

FIG. 5 shows the intelligent controller, according to invention;

FIG. 6 shows the end use device according to the invention.

FIG. 7 shows the interconnection of alternate sources of power: Generator, Wind Power or other sources.

### DETAILED DESCRIPTION OF THE INVENTION

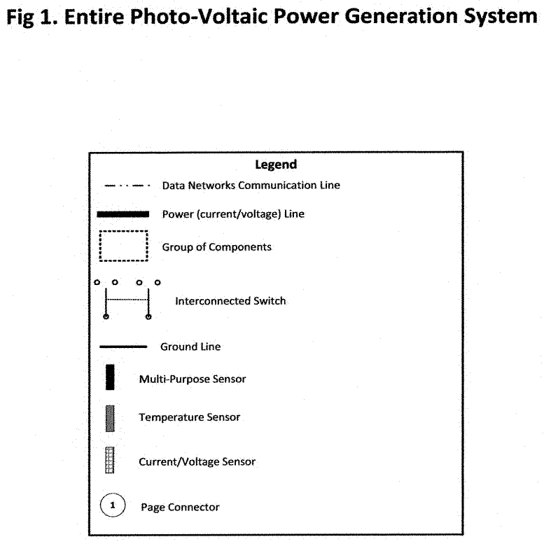

With reference to FIG. 1, it is pointed as a whole with (10) a PV power generation system comprising a single string, (22), of PV modules and related DC power control and delivery components.

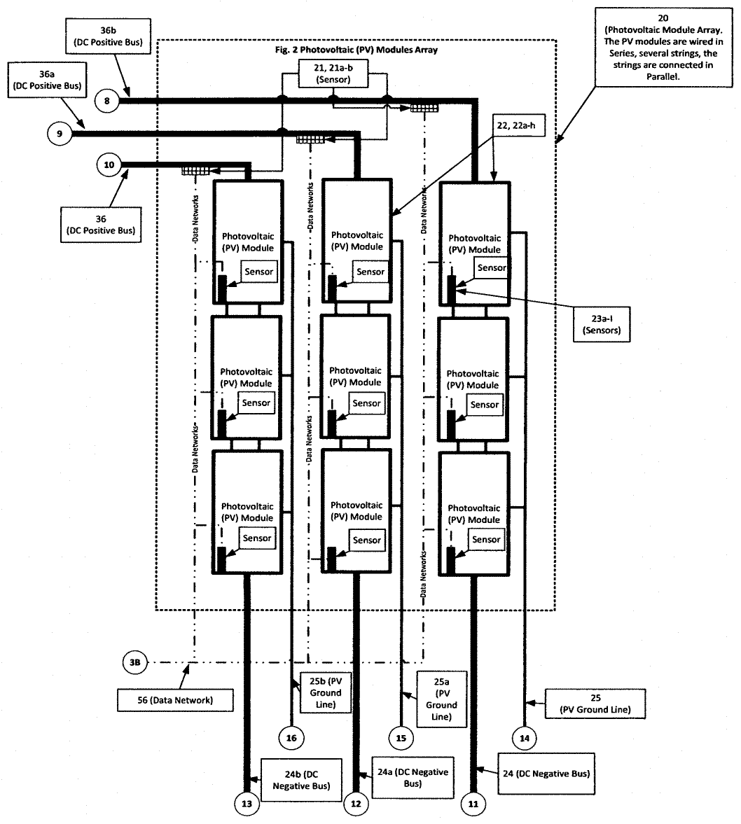

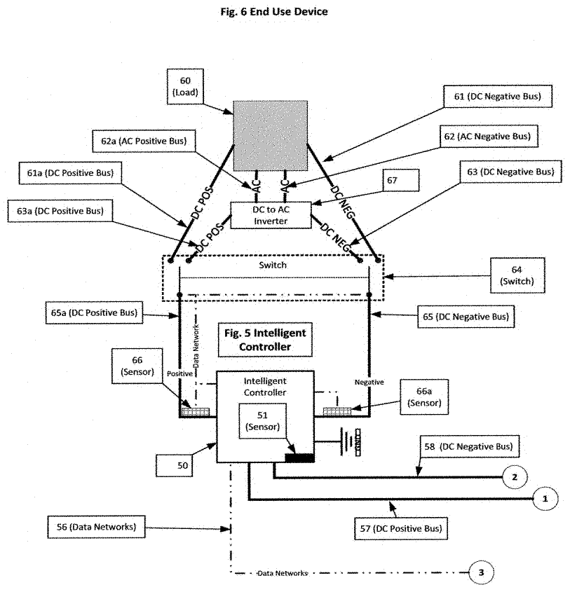

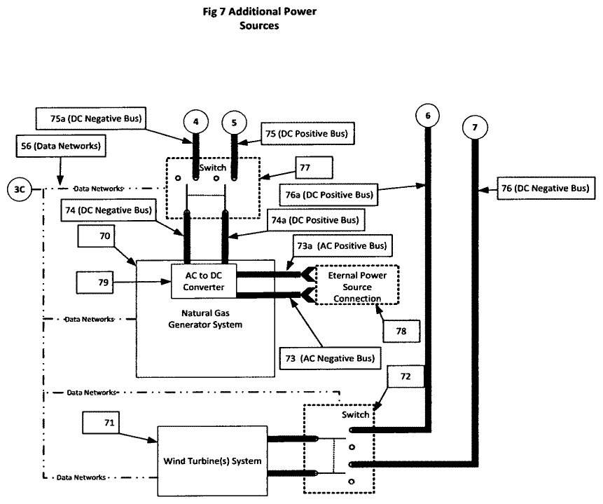

Each PV module is wired to an electronic unit, (FIG. 2: 22, 22a through 22h), which are half the PV modules because two PV modules are connected to each electronic unit. The electronic units, 22 and 22 a through 22h, are wired in series/parallel, just like PV modules in standard PV power generation systems and connected to an inverter (FIG. 6: 67), that could be a mains grid-tie inverter. Through communication means (FIG. 1: 56), a data transmission bus, each electronic unit and status monitoring sensors, communicates with the Intelligent Controller (FIG. 5: 50)

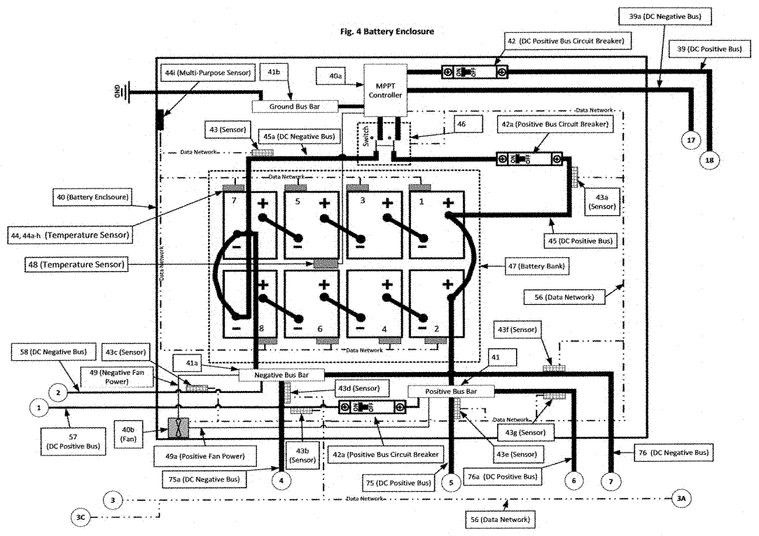

The managing center (Intelligent Controller) (FIG. 5: 50) also comprises Wi-Fi transmission signal processor and antenna; and electronic bridge means (power, signal relay, etc., for transmitting data from the managing center (Intelligent Controller) (FIG. 5: 50) to external devices, e.g., signaling means (FIG. 1: 56), and relay means, thereto for emitting system status and alarm signals as required, and a battery and MPPT charge controller unit (FIG. 4: 40a), to supply power to the system managing unit (Intelligent Controller) (FIG. 5: 50).

The intelligent controller will be built to include a removable memory/firmware device containing a system control program consisting of about 16,000 lines of C+ code. This code may be reconfigured as required to optimize the device for its operating environment, (see Claim 1 above). In this way, the power generation system may be quickly reconfigured to best suit the operating environment in which it is deployed. The system intelligent control unit monitors and at user/owner determined intervals interrogates the PV-panels and batteries, recording and transmitting system operational status to a data collection/analysis station. The entire apparatus (Direct Current (DC) or Alternating Current (AC) electrical power generation system)) may be configured to act as an independent power supply for remote devices.

In FIG. 2 you can see in more detail a portion of the PV power generation system of FIG. 1, represented by nine PV modules wired in series to create a string of 3 and then wired in 3 strings in parallel.

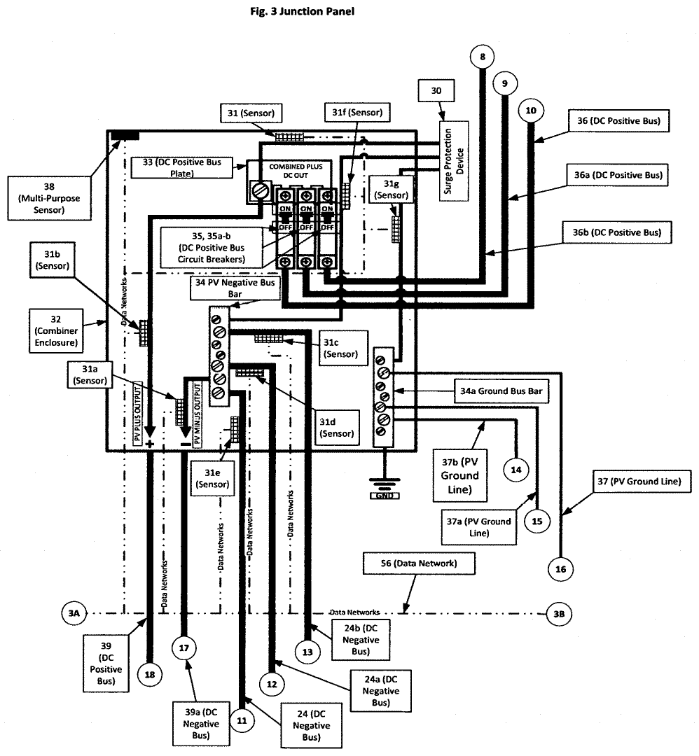

As shown in FIG. 3 an electronic unit, 32, comprises, according to a specific embodiment of the invention: at least two input connection means, 32, 35a-b and 34, for connecting at the output of two PV modules; at least two voltage and current measuring means (FIG. 2: 21, 21a and b), for measuring the voltage and current at the output of the PV modules; at least two power stages of a DC to DC converter/power supply unit; a DC power bus, apt to connect in parallel the outputs of the power stages; further voltage and current measuring means, 31 and 31a, for measuring the voltage and current at the output of the electronic unit; a microprocessor (Intelligent Controller) (FIG. 5: 50), receiving data from the voltage and current measuring means and able to communicate, by suitable communication interfacing means, and the communication means via the above referenced dedicated data/control bus, with the managing unit (Intelligent Controller) (FIG. 5: 50); driving means, controlled by the microprocessor (Intelligent Controller) (FIG. 5: 50) and apt to operate the power stages; alarm means, controlled by the microprocessor (Intelligent Controller) (FIG. 5: 50); and battery charging/power managing means.

The solar charge controller, FIG. 4: 40a, may also be designed to be connected to a single PV module and in this case it does not need the DC power bus or elements of FIG. 3: 32, or it may be connected to a greater number of PV modules, providing in this case further input connection means, more voltage and current measuring means, further power stages, and driving means, thereof.

In a preferred embodiment the DC to DC converter/power supply unit is a boost derived switch mode power converter and the electronic units also comprise batteries, status and connection leads and further digital and analogue I/O connectors.

A preferred embodiment of an electronic unit 31i-n according to FIG. 3 is shown in FIG. 70a-b. In this case the electronic unit (not shown) is connected to two PV modules through the input connection means 21a and 21b. The voltage and current measuring apparatus contain a current sensor and a voltage sensor whereas the further voltage and current measuring means (not shown) contains a voltage sensor and a main switch mode power supply (SMPS) connected to the battery charging/power managing system.

In a preferred embodiment, shown in FIG. 4 the system control/managing unit (Intelligent Controller) (FIG. 5: 50), also comprises memory means (not shown), for data gathering and logging, a supervision engine (not shown), apt to control the status and the activity of the managing unit (Intelligent Controller) (FIG. 5: 50) and an internal bus, (not shown) for internal communication of the previous units.

The MPPT Controller 40a and other system sensors are able to interface with the managing unit (Intelligent Controller) (FIG. 5: 50), via the dedicated data/control link using various communication protocols as necessary to provide periodic system status output/updates.

Thanks to the ability of interfacing data networks (not shown), and to the digital outputs (not shown), the managing unit (Intelligent Controller) (FIG. 5: 50), can be connected to external devices.

The method of the invention and the working principles of an apparatus according to the invention are described in the following.

The intelligent controller is the brain of the entire system. As one would assume from the description, the intelligent controller, through the installed sensors, monitors and controls the entire apparatus. The DC to DC conversion/power supply phase is controlled by the microprocessor 40a that receives data from the measuring means 20i, 31i-l and 40a-g and, together with the microprocessor of the managing unit 40-45, processes them and the voltage and current data of the other electronic units of the string and then send proper signals to the driving means 40a that operate/control the PV panels 22, 22a-h.

Finally, in the above disclosure, the method of the invention is applied to optimize the efficiency of PV modules in PV power generation systems, but it could be advantageously applied to different kinds of DC power generators connected in series. For instance, the method could optimize the efficiency of electric accumulators or fuel cells connected in series in UPS systems., hybrid or electric vehicles or other systems providing series of DC power generators.

These and other variants or modifications may be carried out to the method and apparatus for managing and conditions PV power generation systems according to the invention, still remaining within the ambit of protection as defined by the following claims.

### REFERENCES CITED

U.S. Patent Documents

| | | |
|---|---|---|
| 20030218888 | Nov. 27, 2003 | Suzui et al. |
| 20040159102 | Aug. 19, 2004 | Toyomura |
| | Jan. 10, 2008 | Cornelius |
| 20090153108-A1 | June 2009 | Hendin |
| 20120313442-A1 | December 2012 | Oh |
| 20170201170-A1 | July 2017 | Abu-Hajar |

### FOREIGN PATENT DOCUMENTS

| | |
|---|---|
| 1429394 | June 2004 |
| 03098703 | November 2003 |
| 2008125915 | October 2008 |
| WO 2008125915 | October 2008 |
| WO 2008125915 | October 2008 |

1. An apparatus for generating AC/DC power in which a hybrid system consisting of a wind turbine, natural gas generator and photovoltaic (PV) modules.
The PV modules are wired in series to form a PV system in which the system comprises several strings. The strings are connected in parallel to a DC power bus connected to at least one controller and power conditioner to generate DC power. When desired the system converts DC current to AC current by use of two inverters: a DC to AC inverter to produce alternating current as required; and, a DC inverter, wherein in a string of PV modules a first PV module is wired to a first electronic unit and a second PV module is wired to a second electronic unit, wherein the first and second electronic units are wired in series and connected to the controller and power conditioner as well as an inverter. The system controller shall be custom configurable, in the following manner:
A firmware device consisting of a custom software program written in C+ and about 16,000 lines of code in total, flashed or loaded onto a removable memory device;
The memory device and C+ control program will be configurable to reflect operating conditions—meaning that the deployed energy production device can be optimized to best operate in a wide variety of physical environments
Thus, a system operating in the desert southwest may vary significantly from one deployed in New England or Alaska.
Each electronic unit will be comprised of:
a DC to DC inverter/converter acting upon the voltage or current at the output of the respective PV module;
a DC to AC inverter to produce alternating current as required;
a sensor for measuring the voltage or current at the output of the respective PV module;
a second sensor for measuring the voltage or current at the output of the DC to DC converter;
a dedicated application (software driver) system for operating the DC to DC converter; and at least one microprocessor array specifically configured to control the DC to DC converter for powering and running any number of desired electrical devices;
an Intelligent Controller with software code specifically designed and written to monitor, report and offer remote control of selected apparatus hardware (AC and DC inverters and associated hardware) and software functions controlled by the owner/user via a smart device such as a phone, tablet or laptop;
A firmware device consisting of a custom software program written in C+ and about 16,000 lines of code in total, flashed or loaded onto a removable memory device;

2. The apparatus, according to claim 1, wherein the microprocessors control the power output according to an algorithm operable to optimize the voltage and DC current values at the input of the inverter—if an inverter is used with the overall system. Independent of inverter inclusion into the deployed system, the entire system shall be controlled via a removable firmware device consisting of a custom software program written in C+ and about 16,000 lines of code in total, flashed or loaded onto a removable memory device;

3. The apparatus, according to claim 1, further comprising at least one managing unit operable to manage the electronic units of a string, the managing unit (intelligent controller) comprising at least one microprocessor and a communication system for communicating with each electronic unit of that string in order to send back to the microprocessors new working parameters of the power stages of the DC to DC converters. The intelligent controller shall be designed as an interchangeable, custom configurable and removable memory device. The removable device will contain the device control software program. The intelligent controller will be built to include a removable memory/firmware device containing a system control program consisting of about 16,000 lines of C+ code. This code may be reconfigured as required to optimize the device for its operating environment, (see claim 1 above). In this way, the power generation system may be quickly reconfigured to best suit the operating environment in which it is deployed.

4. The apparatus, according to claim 1, wherein the electronic units also comprise batteries, a battery charging/power managing system and working or a connection status signaling system. Thus, the entire apparatus is a rapidly reconfigurable and variably controlled power generation system, consisting of all components described in claims 1-3 above.

5. The apparatus, according to claim 4, characterized in that the managing units also comprise a memory system, at least one supervision engine operable to control the status and the activity of the managing unit and a communication interfacing system able to interface the managing unit with data networks using various communication protocols for connecting the managing unit with an external device including any one of an acoustic or light signaling system, external PCs, tablet devices, a display system, an external memory system, PLC devices, solar tracking devices for tilting the angle of the PV modules and many other devices as desired. The intelligent controller will be built to include a removable memory/firmware device containing a system control program consisting of about 16,000 lines of C+ code. This code may be reconfigured as required to optimize the device for its operating environment, (see claim 1 above). In this way, the power generation system may be quickly reconfigured to best suit the operating environment in which it is deployed.
